(19) United States
(12) Patent Application Publication
(10) Pub. No.: US 2001/0048174 A1
(43) Pub. Date: Dec. 6, 2001

(54) Shaped resin articles

(76) Inventors: Ryuichi Yamada, Nagoya-shi (JP); Miyuki Ogasawara, Nagoya-shi (JP); Masahito Hoshino, Nagoya-shi (JP); Yasuyuki Ohara, Nagoya-shi (JP)

Correspondence Address: DENNISON, SCHEINER SCHULTZ & WAKEMAN, 612 CRYSTAL SQUARE FOUR, 1745 JEFFERSON DAVIS HIGHWAY, ARLINGTON, VA, 22202-3417, US

(21) Appl. No.: 09/810,338

(22) Filed: Mar. 19, 2001

(30) Foreign Application Priority Data
Mar. 21, 2000 (JP) 2000-078788

(51) Int. Cl. B28B 11/06; B32B 7/02

(52) U.S. Cl. 264/131; 428/212

(57) ABSTRACT

A thermoplastic shaped resin article may include, for example, a shaped base material and a thermoplastic resin sheet. A discontinuous metal film may be disposed on one surface of the resin sheet. The base material may be adhered to the resin sheet so that the metal film faces the base material. As a result, shaped resin articles may be prepared that have a metallic appearance and transmit visible light.

### BACKGROUND OF THE INVENTION

1. Field of the Invention

The present invention relates to shaped articles having a metallic appearance and further relates to methods for manufacturing such shaped articles.

2. Description of the Related Art

Examples of known shaped articles having a metallic appearance are press shaped articles that are press shaped from various metal plates, for example, an aluminum plate, a stainless steel plate or other such metal plates. However, in general, it is difficult to produce press shaped articles having complex shapes from metal plates using press forming techniques.

Other examples of known shaped articles having a metallic appearance are made from shaped resin base materials. These shaped base materials are appropriately finished by surface metal finishing, so as to provide the metallic appearance on the surface. The surface metal finishing of the shaped base materials is generally performed by covering the surface with a thin metal film, for example, nickel, chromium, or other such metals. The thin metal film is directly formed on the resin surface by plating, evaporating, sputtering or other such processes. Alternatively, surface metal finishing processes for shaped base materials can be performed by covering the surface with a resin sheet that is coated with a vapor-deposited metal (hereinafter “metal-coated resin sheets”).

In a manufacturing process of these shaped resin articles, a metal finishing step of the shaped base materials is carried out separately from a forming step. As a result, the manufacturing process is necessarily complicated, thereby increasing manufacturing costs. Further, it is difficult to uniformly form the thin metal film on the surface of a shaped base material having a complex shape. In addition, patterning the thin metal film on the base materials can be difficult. Moreover, if the shaped base material is covered by a metal-coated resin sheet, harmful cracks may be produced on the coated thin film when the metal-coated resin sheet is applied to the base material surface. Because portions of the resin sheet may be excessively stretched in order to follow the shapes of the base materials, cracks may form and detract from the intended metallic appearance.

Moreover, the thin metal film may prevent transmission of vapors and volatile gases that are generated in the base materials due to heating. In fact, these gases may be trapped between the metal-coated resin sheet and the base materials and cause the coated metals to prematurely degrade. Thus, the metallic appearance of the shaped articles will also be degraded.

### SUMMARY OF THE INVENTION

It is, accordingly, an object of the present teachings to teach shaped articles having a metallic appearance that overcome one or more problems of the known shaped articles. In another aspect of the present teachings, improved methods for manufacturing such shaped articles are taught.

In one aspect of the present teachings, a method for manufacturing a thermoplastic shaped resin article may include shaping a thermoplastic resinous base material. Thereafter, a thermoplastic resin sheet may be applied or adhered to one surface of the base material. Preferably, a metal film is disposed on one surface of the resin sheet and the metal film may comprise a collection of metal particles that exist in a discontinuous pattern. The metal film may be formed on the surface of the resin sheet that faces the base material. Thus, shaped resin articles comprising metal films may be formed according to the present teachings.

In addition, this method may be utilized to directly produce thermoplastic shaped resin articles having a special metallic appearance. The shaped resin article may also transmit visible light. Moreover, thermoplastic shaped resin articles according to the present teachings may provide a luminary metallic appearance by illuminating the shaped resin article from the surface opposite of the base material.

Additional objects, features and advantages of the present invention will be readily understood after reading the following detailed description together with the accompanying drawings and the claims.

### BRIEF DESCRIPTION OF THE DRAWING

FIG. 1 is a sectional view showing a manufacturing process of a shaped resin article of an embodiment according to the present teachings, in which a cover material and a base material of the shaped resin article are shown in cross section for illustration purposes.

### DETAILED DESCRIPTION OF THE INVENTION

While researching known shaped resin articles comprising a resin base material covered with a cover material that comprises a resin sheet coated with vapor-deposited metal, it was discovered that disadvantages associated with the known articles, for example, cracking of the coated metal, could be remarkably reduced or eliminated if the properties and form of the coated metal are appropriately selected. In particular, it was found that a microscopically discontinuously patterned metal coating may improve the properties of the product. That is, metal thin films deposited in a discontinuous pattern provide excellent stretchability or extendibility and thus, cracks in the metal film can be reduced or eliminated.

Therefore, improved shaped resin articles may include a base material comprising a thermoplastic resinous material. A cover material may include a cover sheet formed from a thermoplastic resinous material. A metal thin film may be disposed on one surface of the cover sheet. The cover material and the base material may be joined together to provide improved shaped resin articles. Preferably, the metal film is deposited on the cover sheet by vacuum evaporation, sputtering, ion plating or other such processes. In addition, the metal thin film is formed in a microscopically discontinuous pattern or a multi-dot pattern, so as to have an island structure when viewed under magnification.

Such a shaped resin article may be manufactured in the following representative manner. A thermoplastic resinous base material may be prepared and a cover material may be applied to one surface of the shaped base material during or prior to the shaping step. The cover material preferably includes a cover sheet formed from a thermoplastic resinous material and a metal thin film formed on one surface of the cover sheet. Again, the metal thin film preferably comprises a collection of metal particles that exist in a discontinuous pattern.

Further, the resinous material can be shaped by vacuum forming (including pressurized forming), injection molding, blow molding, extrusion molding, compression molding, stern bubble molding and/or stretch film molding.

Detailed representative examples of the present invention, which examples utilize many of these additional features and constructions in conjunction, will now be described in detail with reference to the drawing. This detailed description is merely intended to teach a person of skill in the art further details for practicing preferred aspects of the present teachings and is not intended to limit the scope of the invention. Only the claims define the scope of the claimed invention. Therefore, combinations of features and steps disclosed in the following detail description may not be necessary to practice the invention in the broadest sense, and are instead taught merely to particularly describe some representative examples of the invention, which detailed description will now be given with reference to the accompanying drawing.

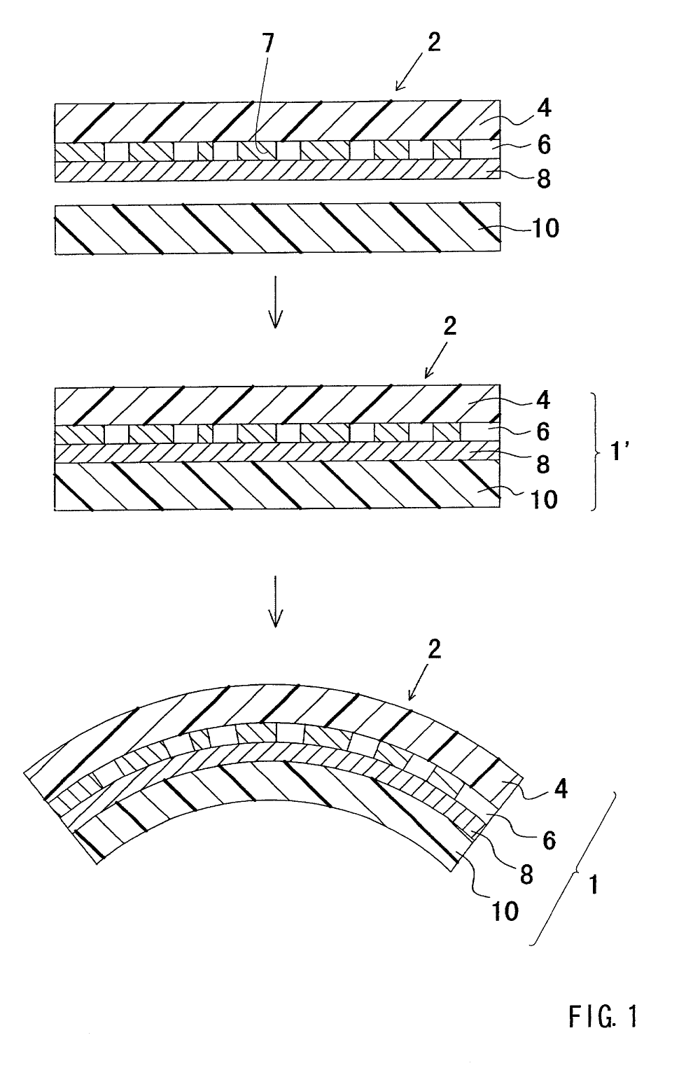

A representative embodiment of the present teachings is shown in FIG. 1, in which a shaped resin article 1 comprises a base material 10 and a cover material 2 that covers the base material 10. The cover material 2 may be adhered to the base material 10, for example, by an adhesive layer 8. The cover material 2 preferably includes a resin sheet 4 and a metal film 6 that is formed on a lower surface of the resin sheet 4. As will be appreciated, this metal film 6 provides a metallic appearance to the resin sheet 4, and as a result, to the shaped resin article 1.

The resin sheet 4 preferably comprises a thermoplastic resinous material that is flexible and can be stretched. Examples of representative thermoplastic resinous materials are polyethylene terephthalate, urethane, acrylic resins, fluoroplastics, vinyl chloride resins and polypropylene. Especially preferred materials are polymethyl methacrylate and a combination of acrylonitrile butadiene styrene polymer and polymethyl methacrylate.

The thickness of the resin sheet 4 is preferably not restricted. However, the thickness is preferably selected, so that the resin sheet 4 may have good flexibility, to thereby reliably follow the base material 10 when the base material 10 is bent or shaped. In general, the resin sheet thickness is preferably about 12-2000 micrometers and most preferably about 30-100 micrometers.

In addition, the resin sheet 4 preferably can be extended or stretched about 100-250% at 20° C. (room temperature) without cracking or tearing, so as to appropriately follow the base material 10 when the base material 10 is shaped. If the resin sheet 4 can not be stretched more than 100%, the resin sheet 4 has less extensibility, which may result in cracks in the metal film 6 of the resin sheet 4 when the base material 10 is shaped. Further, extendability or stretchability of the resin sheet 4 can be increased by heating. For example, the resin sheet 4 may preferably extend or stretch about 100-350% and 150-400% at 80° C. and 120° C., respectively.

The metal film 6 is preferably formed in a microscopically discontinuous pattern or multi-dot pattern. That is, the metal film 6 comprises a collection of isolated island-like or dot-like metal particles 7, each particle covering a very small area. Therefore, the metal film 6 microscopically covers a portion of the lower surface of the resin sheet 4, but does not completely cover the resin sheet lower surface. In other words, the metal film 6 may include a microscopically continuous non-covered area on the resin sheet 4. However, the metal film 6 preferably provides a visible appearance (i.e. macroscopic appearance) that the metal thin film completely covers the resin sheet lower surface. Thus, the resin sheet 4 will have a metallic appearance.

The metal film 6 can be formed from various kinds of metals that may provide such a metallic appearance to the resin sheet 4. However, because the dot-like metal particles 7 of the metal film 6 are typically formed by cohesion of evaporated metal particles, the metal film 6 can be formed using metals that exhibit excellent cohesive properties and good glossiness. Preferably, the metal thin film comprises tin or indium and most preferably tin.

The metal particles or metal coating units 7 of the metal film 6 may have various shapes. That is, the metal particles 7 may have regular shapes such as substantially circular shapes, or irregular or indeterminate shapes. The metal particles 7 preferably may have an average length and width of 30-50 nm×60-90 nm and more preferably 30-40 nm×65-80 nm. Also, spaces between metal particles 7 are preferably about 5-25 nm and more preferably about 9-20 nm. If the metal film 6 comprises such metal particles 7, the metal film 6 can reliably follow flexure of the resin sheet 4 without cracking when the resin sheet 4 is flexed or stretched (extended) by about 100% to 250%. In addition, in one preferred embodiment, the material and the thickness of the resin sheet 4 is preferably selected so that portions of the resin sheet 4 having metal particles 7 disposed thereon do not stretch when the resin sheet 4 is stretched. However, portions of the resin sheet 4 that do not have metal particles 7 disposed thereon will stretch during the stretching operation. Thus, such shaped resin articles 1 will have an excellent surface appearance and provide a desired visible light transmittance (which will be hereinafter described).

It has been found that the metal film 6 preferably has a metal particle covering ratio of approximately 70-90% before the cover material 2 is applied to the shaped base material 10. As a result, this ratio becomes 50-90% when the cover material 2 is applied to the shaped base material 10, so as to be partially stretched. The metal particle covering ratio of 70-90% imparts desirable visible light transmittance and good appearance to the cover material 2 after the cover material 2 is applied to the shaped base material 10. In particular, the metal particle covering ratio of 70-90% imparts visible light transmittance of about 5% to 40% when the cover material 2 is applied to the shaped base material 10 and partly stretched thereon. As a result, a good appearance is imparted to the shaped resin article 1.

If the cover material 2 has such a visible light transmittance, the shaped resin article 1 may exhibit a metallic and luminescent appearance when the shaped resin article 1 is illuminated from a back surface (a surface that does not face the metal film 6) of the base material 10.

The metal film 6 can be formed by vacuum evaporating, sputtering, ion plating or other such film forming processes. As will be readily understood, the size of the metal particles 7 and space therebetween can be preferably determined by controlling the metal deposition rate or other such conditions.

The metal film 6 is not required to be disposed on the entire surface of the resin sheet 4. That is, the metal film 6 can be disposed on only a portion of the resin sheet surface. Also, the metal film 6 may comprise a plurality of metal films. That is, the metal film 6 may be a patterned metal thin film. Such a patterned metal thin film preferably may be formed using a photolithography technique.

A representative photolithography method includes disposing a continuous metal film and then disposing a suitable photoresist on the previously formed metal film. The photoresist is exposed to form a patterned resist and the metal film is etched using by appropriate etchant in order to remove the metal film area that is not covered with the patterned resist. Thus, a discontinuous metal film can be prepared in this manner. Suitable photoresist includes urethane based inks and polyester based inks. The etchant is preferably a sodium hydroxide solution of about 5-15 wt %.

A coating layer (not shown) may be disposed on the outer surface of the metal film 6. Such a coating layer can prevent the metal film 6 from oxidation. In addition, the coating layer may increase the adhesiveness between the metal film 6 and the adhesive layer 8. The coating layer preferably comprises an acrylic resin, a polyester resin or other similar resins.

An additional or decorative layer (not shown) can be further provided on an upper surface of the resin sheet 4 or the outer surface of the metal film 6, so as to increase the ornamental effect or appearance of the shaped resin article 4. Such a decorative layer may have a graphic design and/or may include a colored layer. The decorative layer may be, for example, a print layer that comprises a single color print or a multi color print. Such a print layer is preferably formed from a urethane based ink or an acrylic resin based print ink. Also, the decorative layer may comprise a deposited metal layer that is formed from various kinds of metals by evaporating or other such methods. In addition, the decorative layer is not required to cover the entire surface of the resin sheet upper surface. That is, the decorative layer can be formed in such a way as to cover only a portion of the resin sheet upper surface.

The decorative layer may have one or more supplemental layers. These supplemental layers are not required to cover the entire surface of the resin sheet surface. Further, these supplemental layers may overlap at least a portion of the decorative layer so as to form multiple layered decorative layers. In the alternative, the supplemental layers may be substantially complementary to the decorative layer, so as not to overlap each other. Preferably, these layers are arranged in such a way as to cooperate or harmonize with the opposing metal film 6, so as to increase the ornamental effect of the shaped resin article 1.

A protective layer (not shown) may be disposed on the upper surface of the resin sheet 4 or the outer surface of the metal film 6, so as to protect the resin sheet 4 from degradation. Such a protection layer is preferably utilized when the shaped resin article 1 is intended to be used in an environment that is adverse to the metal layer. The protection layer may be an outermost layer that preferably comprises an acrylic resin, a urethane resin or other such resins. Although the protection layer is preferably transparent or semi-transparent, this layer can be dyed using pigments of a wide variety of colors, if necessary.

The adhesive layer 8 can be made from many kinds of adhesive materials that can reliably bond the cover material 2 to the base material 10. While the thickness of the adhesive layer 8 is not particularly restricted, the thickness is preferably selected in consideration of the extension rate of the resin sheet 4. Generally speaking, the adhesive layer thickness preferably may be about 10-50 micrometers and most preferably about 15-40 micrometers.

The base material 10 may comprise various kinds of thermoplastic resinous materials that have suitable flexibility or extensibility. Representative examples of such thermoplastic resinous materials are polyethylene, polypropylene, polystyrene, AS resins, ABS resins, methacrylic resins, vinyl chloride resins, ethylene vinyl alcohol copolymers, ACS resins, AES resins, polyamide resins, polycarbonate resins, polyacetals, and any combination thereof. In addition, these thermoplastic resinous material may be replaced with thermoplastic elastomers, such as styrene elastomers, olefin elastomers, vinyl chloride elastomers, urethane elastomers, ester elastomers, polyester elastomers, polyamide elastomers, fluoroelastomers, chlorinated polyethylene elastomers, and conjugated butadiene elastomers.

The base material 10 may be utilized in various forms, such as a sheet-like form and a plate-like form. If the base material 10 has a sheet-like form, its thickness is preferably about 50-5000 micrometers and most preferably about 100-3000 micrometers, so that the base material 10 can be reliably shaped. If the thickness is less than 50 micrometers, the possibility is increased that the resin sheet 4 of the cover material 2 will be damaged when the base material 10 is shaped. On the other hand, if the thickness is greater than 5000 micrometers, the base material 10 may not suitably flex or stretch when shaped.

Representative methods for manufacturing the shaped resin article will now be described.

The metal film 6 may be disposed on the lower surface of the resin sheet 4, for example, by vacuum evaporation, so as to form the cover material 2. Further, the metal film 6 may be formed while suitably adjusting the deposition rate of the metal, so as to provide a desired visible light transmittance. This cover material 2 may be preferably coated with the adhesive layer 8.

Thereafter, the cover material 2 is laminated to the non-shaped base material 10, which may comprise a thermoplastic resinous material, to thereby produce a laminate material 1′. Although the cover material 2 of this embodiment is preferably laminated to the base material 10 so that the metal film 6 faces the base material 10 as shown in FIG. 1, the cover material 2 can be laminated to the base material 10 so that the resin sheet 4 faces the base material 10 (not shown).

This laminate material 1′ may then be shaped using a desired shaping process, for example, vacuum forming. As a result, the base material 10 can be shaped together with the cover material 2, to thereby form the shaped resin article 1 in which the cover material 2 is reliably adhered to the shaped base material 10.

The shaped resin article 1 also can be manufactured by extrusion molding or blow molding. That is, the shaped resin article 1 can be manufactured without producing the laminate material 1′. In this case, the base material 10 may be formed by extrusion molding or blow molding, and at the same time, the cover material 2 is adhered to the formed base material 10, to thereby form the shaped resin article 1 in which the cover material 2 is reliably adhered to the shaped base material 10. That is, the cover material 2 and the base material 10 are co-shaped and are joined to each other. To perform this direct manufacturing process, the cover material 2 is fed into or arranged in a die (not shown) in such a way that the resinous material of the base material 10 contacts the cover material 2 when the cover material 10 is shaped. In addition, the cover material 2 is typically arranged in the die so that the metal film 6 contacts the base material 10.

Further, the cover material 2 can be preferably pre-shaped, so as to facilitate co-shaping of the cover material 2 and the base material 10, when the shaped resin article 1 is manufactured by injection molding or blow molding. In general, pre-shaping of the cover material 2 can be preferably performed by vacuum forming or pressurized forming.

According to the present process, when the base material 10 is shaped, the resin sheet 4 of the cover material 2 may follow flexure of the base material 10 without separating from the surface of the base material 10. Also, the metal film 6 may reliably follow flexure of the base material 10 without cracking, because the metal film 6 comprises metal particles 7 that are isolated or separated from each other. Moreover, if the cover material 2 is adhered to the base material 10 so that the metal film 6 faces the base material 10, the shaped resin article 1 may have a specular or mirrored metallic appearance, because the metal film 6 has a smooth visible surface that is smoothed (flattened) by the lower surface of the resin sheet 4 during evaporation. In addition, the resin sheet 4 may function as a protective layer, so as to improve the wear resistance of the shaped resin article 1. Naturally, the resin sheet may also improve the weather resistance, solvent resistance, corrosion resistance or other resistance of the shaped resin article 1. As a result, the shaped resin article 1 may have a good appearance that is substantially the same as the laminate material 1′, and may retain the good appearance for a long period of time, even if it is used in a harsh environment.

According to this representative process, the shaped resin article 1 may have a substantially uniform metallic appearance over its entire visible surface regardless of its curvature variation, due to excellent following performance or flexibility of the resin sheet 4 and the metal film 6. Therefore, it is possible to easily produce a shaped resin article 1 that has a closed shell-like shape, a cylindrical shape, a box-like shape or other such complex shapes.

Further, because metal film 6 is formed in a microscopically discontinuous pattern, the metal film 6 may produce passages between the cover material 2 and the base material 10. These passages permit transmission and release of gases (vapors and volatile gases) that may be produced from the base material 10 when the shaped resin article 1 is manufactured. Therefore, these passages will prevent gases from being trapped between the cover material 2 and the base material 10, which could degrade the appearance of the shaped resin article 1. Further, this gas release function may reduce degradation of the coated metals, due to such trapped gases. Therefore, the metallic appearance of the shaped resin article 1 can be reliably preserved.

Moreover, limitations on the composition of the base material 10 are removed and the base material 10 can be made from a material that may generate gas during the manufacturing process. For example, the base material 10 may comprise methacrylic resins, polyamide resins and polycarbonate resins. In addition, this gas release function is retained by the shaped resin article 1 during use of the manufactured product. As a result, the metal film 6 is not subject to effects of trapped gases even if the shaped resin article 1 is used at elevated temperatures, thereby preventing early deterioration of the shaped resin article 1 and preventing partial peeling of the cover material 2.

Further, if the decorative layer or the protection layer is included in the cover material 2, such a layer may be previously disposed on the metal film 6 or the resin sheet 4.

If the base material 10 is made from a transparent or semi-transparent material, the shaped resin article 1 may have a metallic appearance and may transmit visible light. Such a shaped resin article 1 may be illuminated from the back surface of the base material 10 (the surface that does not face the metal film 6) using a desired light source, so as to change the appearance of the shaped resin article 1. In fact, the appearance of the shaped resin article 1 can be controlled by changing illumination colors of the light source. In addition, if the cover material 2 includes a decorative layer, the graphic design of the decorative layer may be emphasized by the illumination. That is, shaped resin article 1 may be prepared that exhibit either a normal metallic appearance and/or a luminous appearance, by utilizing either a transparent or semi-transparent base material 10.

The shaped resin article 1 can be additionally processed by embossing, stamping or other such forming processes, if necessary.

The present shaped resin articles, and in particular the light transmittable shaped resin articles, may have a variety of uses, including as, for example, switches, three-dimensional advertising displays, special containers, shades for lighting equipment and various housings.

The following examples are provided to further illustrate the present invention and should not be construed as limiting the invention.

### EXAMPLE 1

A lower surface of a polyurethane film having a thickness of 40 micrometers was covered with a thin film of tin using a vacuum evaporator, so as to produce a cover material. The tin thin film was formed in the discontinuous pattern described above by controlling the tin deposition rate. An acrylic pressure-sensitive adhesive material having a thickness of 25 micrometers was then coated on the tin thin film. The adhesive coated cover material was laminated to a sheet-like acrylic resin base material having a thickness of 2 mm (ACRYLITE E-IR #001; Mitsubishi Rayon), to thereby form a laminate material as sample 1. The chemical composition of ACRYLITE E-IR #001 is polymethyl methacrylate.

### EXAMPLE 2

A lower surface of a polyurethane film having a thickness of 40 micrometers was covered with a thin film of tin using a vacuum evaporator, so as to produce a cover material. The tin thin film was formed in the discontinuous pattern described above by controlling the tin deposition rate. An acrylic pressure-sensitive adhesive material having a thickness of 25 micrometers was then coated on the tin thin film. The adhesive coated cover material was laminated to a sheet-like ABS resin base material having a thickness of 2 mm (LAMISTUCK; Shin Kobe Electric), to thereby form a laminate material as sample 2. The chemical composition of LAMISTUCK is a combination of acrylonitrile butadiene styrene and polymethyl methacrylate.

### EXAMPLE 3

Control

A lower surface of a polyethylene terephthalate film having a thickness of 25 micrometers was covered with a thin film of chromium using a vacuum evaporator, so as to produce a cover material. The chromium thin film was formed in a conventional continuous pattern. An acrylic pressure-sensitive adhesive material having a thickness of 25 micrometers was then coated on the tin thin film. The adhesive coated cover material was laminated to a sheet-like acrylic resin base material having a thickness 2 mm (ACRYLITE E-IR #001; Mitsubishi Rayon), to thereby form a laminate material as sample 3.

### EXAMPLE 4

Control

A lower surface of a polyethylene terephthalate film having a thickness of 40 micrometers was covered with a thin film of aluminum using a vacuum evaporator, so as to produce a cover material. The aluminum thin film was formed in a conventional continuous pattern. An acrylic pressure-sensitive adhesive material having a thickness of 25 micrometers was then coated on the tin thin film. The adhesive coated cover material was laminated to a sheet-like acrylic resin base material having a thickness 2 mm (ACRYLITE E-IR #001; Mitsubishi Rayon), to thereby form a laminate material as sample 4.

Samples 1-4 were then processed by vacuum forming, so that the base materials were shaped with the cover materials at various extension rates (50%, 100% and 150%), to thereby produce shaped resin article samples. That is, the samples 1-4 were stretched after formation by various degrees of stretching (50%, 100% and 150%). Further, the vacuum forming was performed using the following conditions shown in Table I.

TABLE I

| | |
|---|---|
| Shaping Temperature | 130° C.* |
| Heating Time | 80 seconds |
| Type of Die | Concave or box-like |
| Die Temperature | 25° C. |
| Shaping Time | 60 seconds** |

*The top surface of the laminate material was heated using an infra-red heater.
**This time includes a cooling time of 30 seconds.

The results of preparing samples 1-4 are shown in Table II. For purposes of evaluation, the visual appearance of each shaped resin article sample was observed.

TABLE II

| | Extension Rates | | |
|---|---|---|---|
| | 50% | 100% | 150% |
| Sample 1 | A | A | A |
| Sample 2 | A | A | A |
| Sample 3 (Control) | B | C | C |
| Sample 4 (Control) | A | B | C |

A: Excellent metallic appearance
B: Inferior metallic appearance
C: Remarkably inferior metallic appearance

As will be apparent from Table II, both samples 1 and 2 exhibited a good appearance with regard to all of the examined extension rates (50%, 100% and 150%), whereas samples 3 and 4 (controls) did not exhibit a good appearance except for the extension rate of 50%. This demonstrates that the present teachings can provide a laminate material that can maintain good appearance even if it is stretched and shaped at higher extension rates. Thus, shaped resin article can be prepared having a good metallic appearance regardless of variation in curvature.

What is claimed is:

1. A method of manufacturing a shaped resin article comprising:
forming a discontinuous metal film on one surface of a thermoplastic resin sheet, wherein the metal film comprises a collection of individual metal particles,
applying a shaped thermoplastic resinous base material to the thermoplastic resin sheet, whereby an intermediate product is formed and
stretching the intermediate product to form a shaped resin article having a visible light transmittance of about 5-40%.

2. A method as defined in claim 1, wherein the resin sheet is provided on the base material in such a way that the metal film faces the base material.

3. A method as defined in claim 1, wherein the metal particles comprise tin.

4. A method as defined in claim 1, wherein the shaped resin article has a specular metallic appearance.

5. A method as defined in claim 1, wherein the visible light transmittance of the metal film coated resin sheet is about 5-15%.

6. A method as defined in claim 1, wherein the metal particles have an average length and width of about 30-50 nm by about 60-90 nm, and wherein spaces between the metal particles are preferably about 5-25 nm.

7. A method as defined in claim 1, further comprising the step of providing a colored layer on the other surface of the thermoplastic resin sheet.

8. A method as defined in claim 1, further comprising the step of pre-shaping the thermoplastic base material.

9. A method as defined in claim 1, wherein the resin sheet is about 12-2000 micrometers in thickness, the intermediate product is stretched between about 100-250% and the visible light transmittance of the metal film coated resin sheet is about 5-15% after stretching.

10. A thermoplastic shaped resin article, comprising:
a shaped thermoplastic resinous base material; and
a thermoplastic resin sheet having a metal film that is formed on one surface thereof, the metal film comprising a collection of metal particles that exist in a discontinuous pattern, the resin sheet being applied on one surface of the base material in such a way that the metal film faces the base material, wherein the resin sheet and the base material have been stretched, and wherein the metal film coated resin sheet has a visible light transmittance of about 5-40%.

11. An article as defined in claim 10, wherein a colored layer is provided on the other surface of the thermoplastic resin sheet.

12. An article as defined in claim 10, wherein the metal film has a metal particle covering ratio of about 50-90%.

13. An article as defined in claim 10, wherein the metal film forms a visually recognizable pattern.

14. An article as defined in claim 10, wherein the metal film coated resin sheet has a visible light transmittance of about 5-15%.

15. An article as defined in claim 10, wherein the shaped resin article exhibits a specular appearance when the shaped resin article is illuminated from the other surface of the base material.

16. An article as defined in claim 10, wherein a colored layer is provided on the other surface of the thermoplastic resin sheet, wherein the metal film has a metal particle covering ratio of about 50-90%, wherein the metal film forms a visually recognizable pattern, wherein the metal film coated resin sheet has a visible light transmittance of about 5-15%, and wherein the shaped resin article exhibits a specular appearance when the shaped resin article is illuminated from the other surface of the base material.

17. An article as defined in claim 10, wherein the resin sheet is about 12-2000 micrometers in thickness, the resin sheet and base material are stretched between about 100-250% and the visible light transmittance of the metal film coated resin sheet is about 5-15% after stretching.

18. An article as defined in claim 17, wherein the resin sheet comprises polymethyl methacrylate.

19. An article as defined in claim 18, wherein the resin sheet further comprises acrylonitrile butadiene styrene polymer.

20. An article of manufacture comprising:
a base material comprising a resinous material and having a thickness of between about 50-5000 micrometers,
a resin sheet comprising polymethyl methacrylate adhered to the base material, the resin sheet having a thickness of between about 12-2000 micrometers and
a metal film disposed on the resin sheet, the metal film comprising a collection of individual metal particles, wherein the base material and the resin sheet are stretched after the base material has been adhered to the resin sheet to extend the resin sheet and base material between about 100-250%, wherein the article of manufacture has a metal covering ratio of about 50-90% and a visible light transmittance of about 5-15% after the base material and the resin sheet have been stretched.
